(19) United States
(12) Patent Application Publication
(10) Pub. No.: US 2021/0264327 A1
(43) Pub. Date: Aug. 26, 2021

(54) SYSTEM AND METHOD FOR MANAGING RENTAL OF A VEHICLE

(71) Applicants: Sébastien Blouin, Saint-Georges (CA); Francis Roy, Saint-Georges (CA); Martin Hubert, Saint-Georges (CA)

(72) Inventors: Sébastien Blouin, Saint-Georges (CA); Francis Roy, Saint-Georges (CA); Martin Hubert, Saint-Georges (CA)

(21) Appl. No.: 17/181,835

(22) Filed: Feb. 22, 2021

Related U.S. Application Data
(60) Provisional application No. 62/979,823, filed on Feb. 21, 2020.

(51) Int. Cl. G06Q 10/02; G07C 5/08; G06Q 30/00; G01S 19/14; G01S 19/42

(52) U.S. Cl. CPC G06Q 10/02; G07C 5/0841; G06Q 30/018; G06Q 30/0645; G01S 19/42; G06Q 2240/00; G01S 19/14

(57) ABSTRACT

A system for reserving a movable equipment such as a trailer is disclosed. The system includes a user tracking device configured to track a location of a user. The system includes a reservation management system configured to receive the location of the movable equipment and the location of the user. The reservation management system is configured to provide to a user device the location of the movable equipment, a pick-up point for picking the movable equipment and/or access instructions to the movable equipment at the pick-up point. The reservation management system is further configured to determine whether the user has activated reservation of the movable equipment at the pick-up location.

### FAMILY DETAIL

This is a Patent Cooperation Treaty application which claims the benefit of 35 U.S.C. § 119 based on the priority of U.S. Provisional patent application No. 62/979,823 filed on Feb. 21, 2020, which is incorporated by reference in its entirety.

### FIELD OF THE DISCLOSURE

The present subject matter relates to systems and methods for managing rental of a movable equipment such as a trailer.

### BACKGROUND OF THE DISCLOSURE

Vehicles such as trailers can be used to haul a wide variety of items or cargo. For example, a trailer can be used to carry one or more of motorcycles, all-terrain vehicles, snowmobiles, or a personal watercraft. A person moving household goods might also want to use a trailer to carry mattresses, furniture, and boxes. Any of these activities often involve carrying a number of differently shaped items securely on a trailer.

Various businesses operate movable equipment including trailers for the transportation of cargo and may also offer trailer rental services to third parties. However, before and/or after renting a trailer, a renter usually inspects the trailer for damages. The renter usually does not know whether the trailer has been damaged and/or was involved in an accident during its rental period. In particular, the renter does not know the location of the damages to the trailer. Even after inspecting the trailer, the renter may not locate all damages to the trailer. For example, an unfortunate havoc can occur if a damaged trailer has a problem going down the highway and its contents get spilled; the content of the trailer can be damaged or destroyed and other people can be hurt. Safety inspections of trailers minimize the chances of that happening. A thorough inspection of the trailer might take hours to complete.

Furthermore, an owner of a trailer might want to rent his/her movable equipment such as a trailer that is otherwise unused or not operated efficiently. For example, the owner wishing to rent his/her trailer does not typically have an efficient process or platform to record all information pertaining to the rental of his/her trailer to a third party, including contract generation, inspection process, records of damages to the trailer, and geolocation of the trailer. More specifically, the owner will typically record this information and documentation manually on paper and make rental arrangements verbally with known third parties.

### SUMMARY OF THE DISCLOSURE

According to one aspect of the present subject matter, there is disclosed a system for reserving a movable equipment, including:

a tracking device configured to track a location of a user; and

a reservation management device configured to:
receive the location of the movable equipment;
receive the location of the user;
provide the location of the movable equipment, a pick-up point for picking the movable equipment and/or access instructions at the pick-up point; and
determine whether the user has activated reservation of the movable equipment at the pick-up location.

For example, the reservation management device is configured to provide a summary of the reservation, specifications of the movable equipment and existing damages to the movable equipment.

For example, the reservation management device is configured to determine whether the movable equipment is equipped with a temperature control unit and register engine hours of the temperature control unit.

For example, the reservation management device is configured to determine damages to the movable equipment.

For example, the reservation management device is configured to provide reported damages to the movable equipment to the user, prompt the user to identify and/or validate damages to the movable equipment and register the damages reported by the user.

For example, the reservation management device is configured to provide instructions with respect to inspection, setup and operation of the movable equipment to the user and register user feedback.

For example, the reservation management device is configured to provide to the user a return location for returning the movable equipment, register a mileage for the movable equipment and determine whether the user has de-activated reservation of the movable equipment at the return location.

For example, the reservation management device is configured to prompt the user to identify the movable equipment.

For example, the reservation management device is configured to guide the user in inspecting parts of the movable equipment.

For example, the first tracking device and the second tracking device include GPS receivers.

According to one aspect of the present subject matter, there is disclosed a method for reserving a movable equipment executed by a reservation management device, including:
receiving a location of the movable equipment;
receiving a location of the user;
providing the location of the movable equipment, a pick-up point for picking the movable equipment and/or access instructions at the pick-up point; and
determining whether the user has activated reservation of the movable equipment at the pick-up location.

For example, the method includes providing a summary of the reservation, specifications of the movable equipment and existing damages to the movable equipment.

For example, the method includes determining whether the movable equipment is equipped with a temperature control unit and registering engine hours of the temperature control unit.

For example, the method includes determining damages to the movable equipment, providing reported damages to the movable equipment to the user, prompting the user to identify and/or validate damages to the movable equipment and registering the damages reported by the user.

For example, the method includes providing instructions of the movable equipment owner of the user, registering user feedback, providing to the user a return location for returning the movable equipment, registering a mileage for the movable equipment, and determining whether the user has de-activated reservation of the movable equipment at the return location.

For example, the method includes prompting the user to identify the movable equipment and guiding the user in inspecting parts of the movable equipment.

### BRIEF DESCRIPTION OF THE DRAWINGS

FIG. 1 illustrates an operating environment comprising a system for managing rental of a movable equipment.

FIGS. 2 to 33 illustrate embodiments of a system for managing rental of a movable equipment.

### DETAILED DESCRIPTION OF THE DISCLOSURE

The following examples are presented in a non-limitative manner.

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, data storage systems (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance (PDA), cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present subject matter.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Disclosed herein is systems and methods for reserving a movable equipment. For example, a movable equipment can be any device, machine, equipment, supplies and furniture. For example, a movable equipment can be any vehicle, equipment or machinery that is powered or unpowered, used to do work and/or moved within or between work sites. For example, a movable equipment can be moved from one location to another location. Examples of a movable equipment can include: a vehicle, a trailer, a container (e.g. transport container, freight container, etc.), a shipping crate, a truck trailer, an auto cart, a wagon, a house trailer, a mobile home, a semi-trailer, a semi-truck, a cargo carrier, a caravan, an RV, and a camp trailer.

The system can include a first tracking device configured to track a location of the movable equipment and a second tracking device configured to track a location of a user. For example, the user can reserve the movable equipment from the platform. The system also includes a reservation management device configured to receive the location of the movable equipment (for e.g. from a tracking device), receive the location of the user (for e.g. from a tracking device), provide the location of the movable equipment, a pick-up point for picking the movable equipment and/or access instructions at the pick-up point, and determine whether the user has activated reservation of the movable equipment at the pick-up location. The first tracking device and the second tracking device can include GPS trackers/receivers. The reservation management device can be configured to provide a summary of the reservation, specifications of the movable equipment and existing damages to the movable equipment.

The reservation management device can be configured to determine whether the movable equipment is equipped with a temperature control unit and register engine hours of the temperature control unit. The reservation management device can also be configured to determine damages to the movable equipment, provide reported damages to the movable equipment to the user, ask the user to report other damages to the movable equipment and register the damages reported by the user. The reservation management device can further be configured to provide instructions of the movable equipment owner of the user and register user feedback.

The reservation management device can be configured to provide to the user a return location for returning the movable equipment, register a mileage for the movable equipment, and determine whether the user has de-activated reservation of the movable equipment at the return location. The reservation management device can also configured to ask the user for a picture, video and/or other media of the plate number of the movable equipment and the plate number. The reservation management device can further be configured to guide the user to take pictures of parts of the movable equipment.

A method for reserving a movable equipment executed by a reservation management device is disclosed in the present subject matter. The method can include receiving a location of the movable equipment, receiving a location of the user, providing the location of the movable equipment, a pick-up point for picking the movable equipment and/or access instructions at the pick-up point, and determining whether the user has activated reservation of the movable equipment at the pick-up location. The method can also include providing a summary of the reservation, specifications of the and existing damages to the movable equipment.

The method can include determining whether the movable equipment is equipped with a temperature control unit and registering engine hours of the temperature control unit. The method can also include determining damages to the movable equipment, providing reported damages to the movable equipment to the user, asking the user to report other damages to the movable equipment, and registering the damages reported by the user. The method can further include providing instructions of the movable equipment owner of the user, registering user feedback, providing to the user a return location for returning the movable equipment, registering a mileage for the movable equipment, and determining whether the user has de-activated reservation of the movable equipment at the return location. Furthermore, the method can include asking the user for a picture of the plate number of the movable equipment and the plate number, and guiding the user to take pictures of parts of the movable equipment.

Advantageously, the present subject matter provides a system and method for allowing movable equipment owners to advertise/offer their movable equipment for rent, facilitating a smooth transaction between movable equipment owners and renters and providing guidance to renters (such as inexperienced renters, etc.) when inspecting a movable equipment before use. Advantageously, the present subject matter provides systems. methods and devices for facilitating social distancing between movable equipment owners/administrators and renters and automating transactions between these parties.

For example, the system and method described in the present subject matter provide tools for inspecting movable equipment such as vehicles. For example, the system and method described herein can help identifying movable equipment maintenance issues for attention before they damage a tow vehicle or the movable equipment. For example, by guiding a user in inspecting a movable equipment, the present system and method provide significant risk reduction (e.g. accident prevention, etc.) and cost savings (insurance cost reduction, etc.).

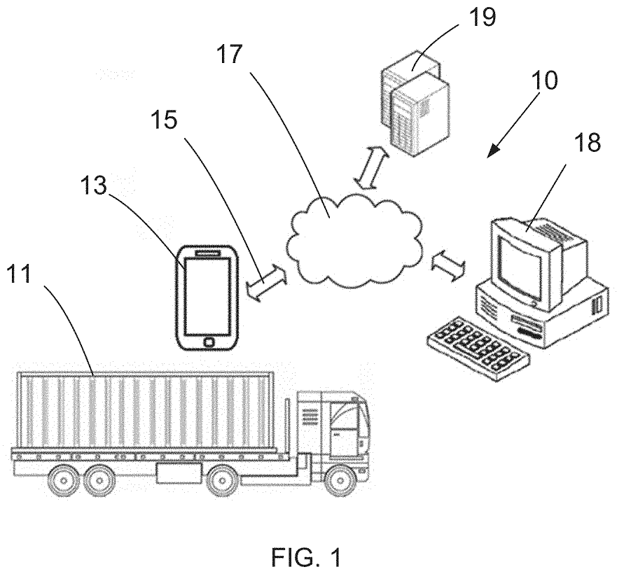

FIG. 1 illustrates an operating environment comprising a system 10 for managing rental of a movable equipment 11. For example, the movable equipment may include, but is not limited to, a vehicle, a car, a truck, a boat, a bus, a trailer, heavy equipment, machinery, etc.

A user may access the system by using an electronic communication device 13, such as, but not limited to, a smartphone, a tablet, a laptop and a desktop.

The electronic communication device may include one or more of: a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. The processor may execute applications, computer readable instructions or programs. The applications, computer readable instructions or programs may be stored in memory or in secondary storage, or may be received from the network.

Further, the user may access functions of the system through the network 17 via a connection 15. The connection may be a wired or a wireless connection. For example, the user can access the system via a cloud environment, the Internet, an Intranet, a Local Area Network (LAN), a Wide Area Network (WAN) and a Metropolitan Area Network (MAN).

For example, the user may include a vehicle owner, a renter, a mechanic or an administrator. The user may access the system via a software application such as a smartphone application or via or an Internet browser.

The system 10 can include a server platform 19, which communicates with a plurality of user devices. The server platform 19 can be a purpose-built machine designed specifically for implementing functions of the system for managing rental of a vehicle. The server platform may be a server computer, desktop computer, notebook computer or another computing device. The server platform can be connected to the network by a wired or wireless connection. The system 10 can include an administrator device for managing the system 10.

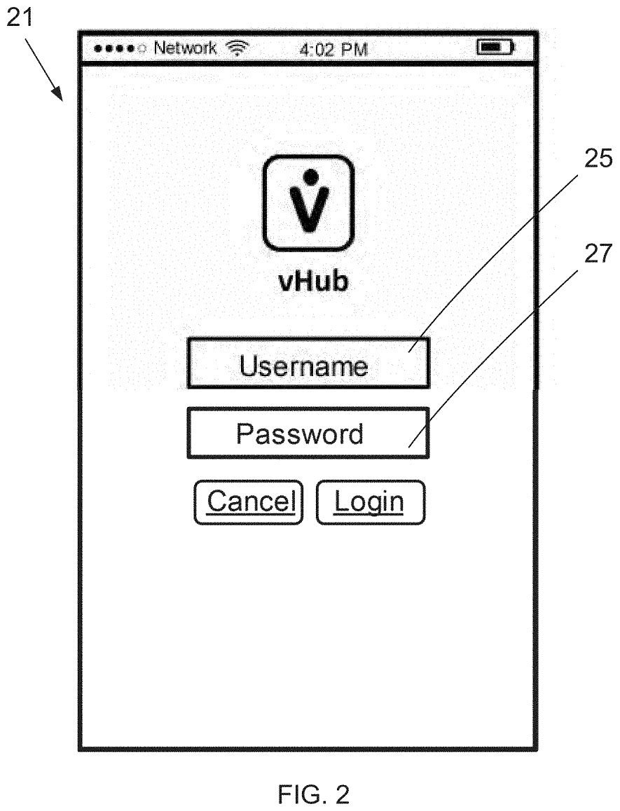

FIG. 2 shows an application 23 running the system for managing rental of a movable equipment on an electronic device 21. For identification purposes, the user can enter his username 25 and password 27 to login into the application.

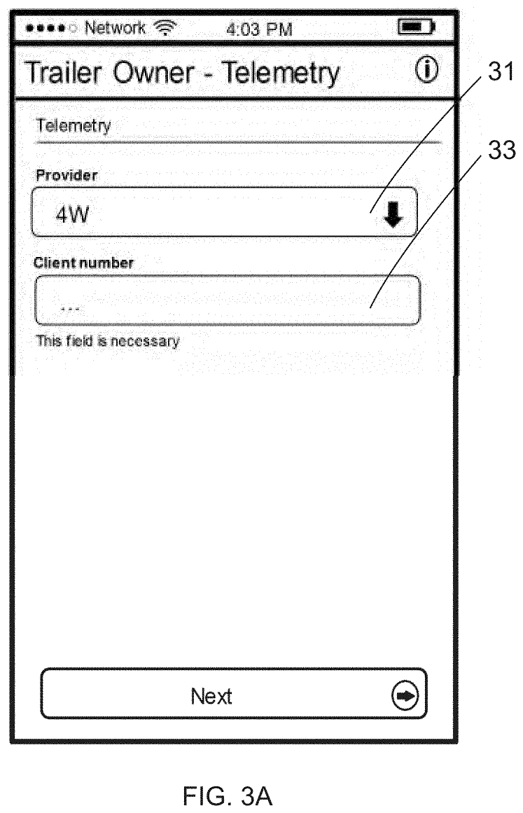

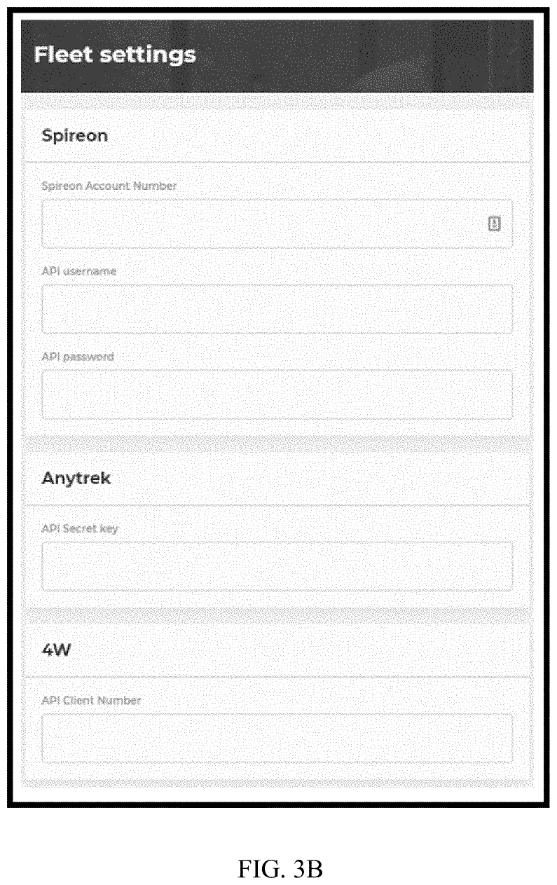

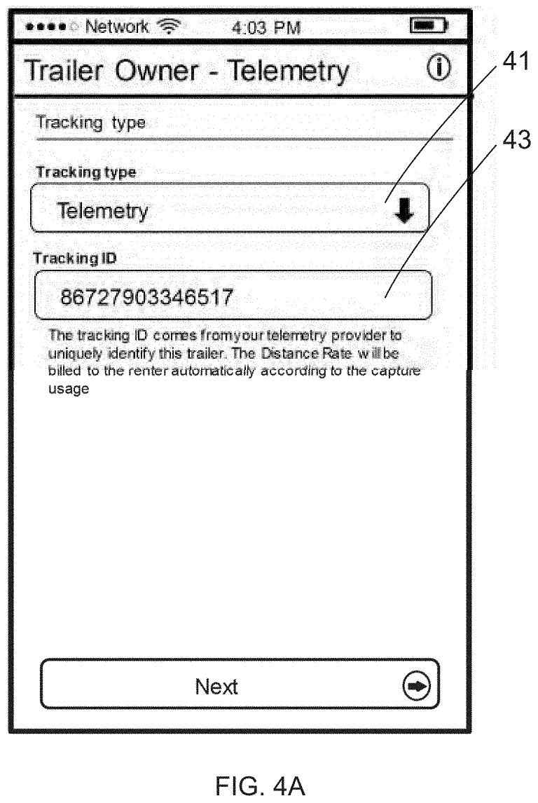

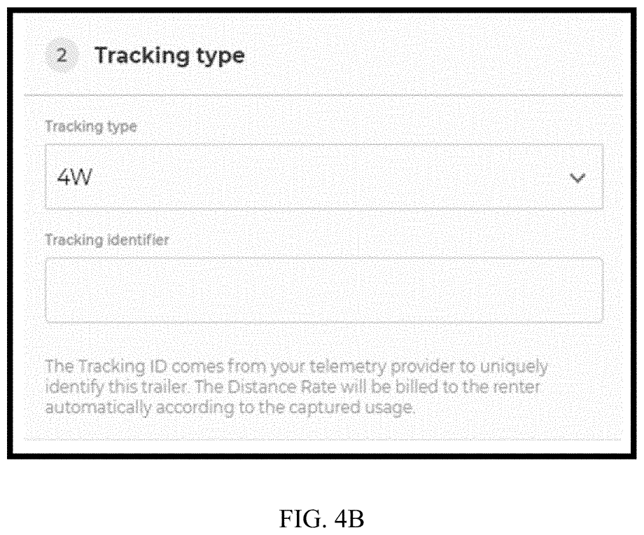

If the user is a movable equipment owner, the application directs her to enter the telemetry system provider 31 of her movable equipment and her client number 33 as shown in FIG. 3A. In FIG. 4A, the owner is asked to enter the tracking type 41 and the tracking ID 43 of the movable equipment. For example, the tracking ID can come from a telemetry provider to uniquely identify the movable equipment. For example, the Distance Rate of the movable equipment can be billed to a renter automatically according to the capture usage. Please note that FIG. 3B shows an alternative embodiment of the subject matter of FIG. 3A; and FIG. 4B shows an alternative embodiment of the subject matter of FIG. 4A.

Advantageously, the system and methods described in the present subject matter provides a platform for an owner to rent his movable equipment including vehicles, machinery trailers, etc. The platform can record all information pertaining to the rental of the movable equipment to a third party, including contract generation, inspection process, records of damages to the movable equipment, and geolocation of the movable equipment.

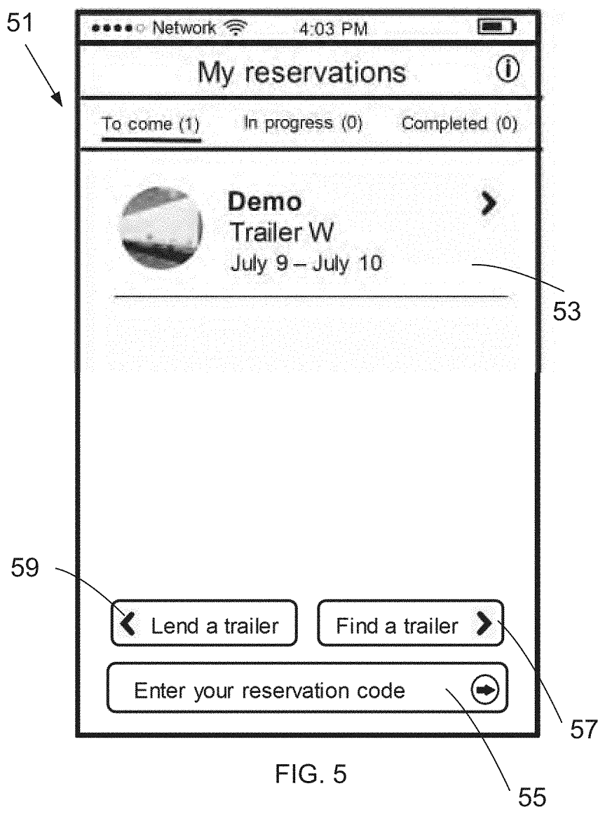

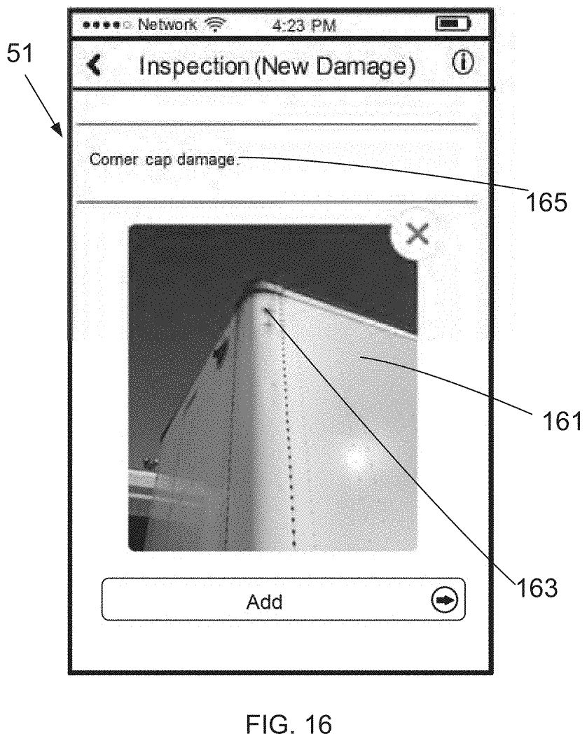

FIGS. 5 to 19 show embodiments of the system for activating of a rental of a movable equipment. For example, a user (e.g. renter, driver, etc.) can access the system's application from a home screen of an iOS™ or Android™ device. In particular, once logged into the application running on the device 51, a renter can see the status of his reservation 53 as shown in FIG. 5. The renter may enter a reservation code to find a reservation by clicking on the button “Enter your reservation code” at 55.

The renter may also find a movable equipment such as a trailer for rent by clicking on the button “Find a trailer” at 57. If the renter wishes to rent his trailer, the renter may start the process of registering his trailer into the system by clicking on the button “Lend a trailer” at 59.

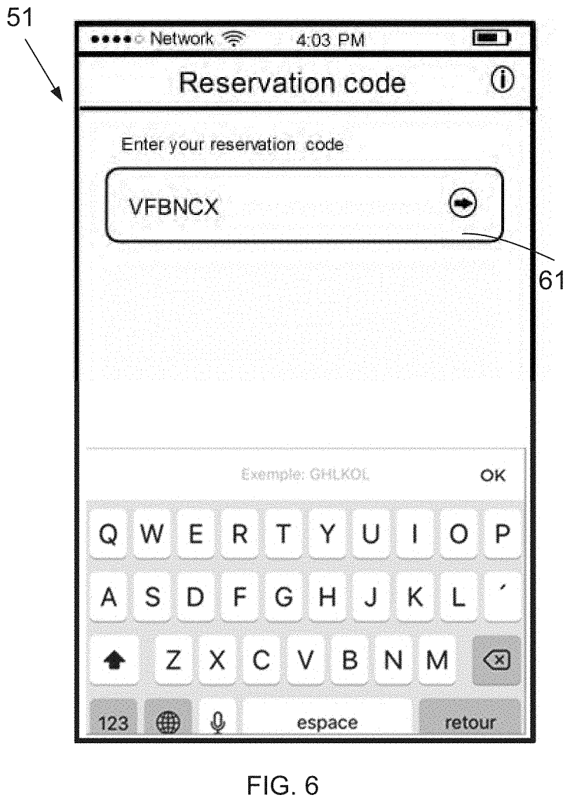

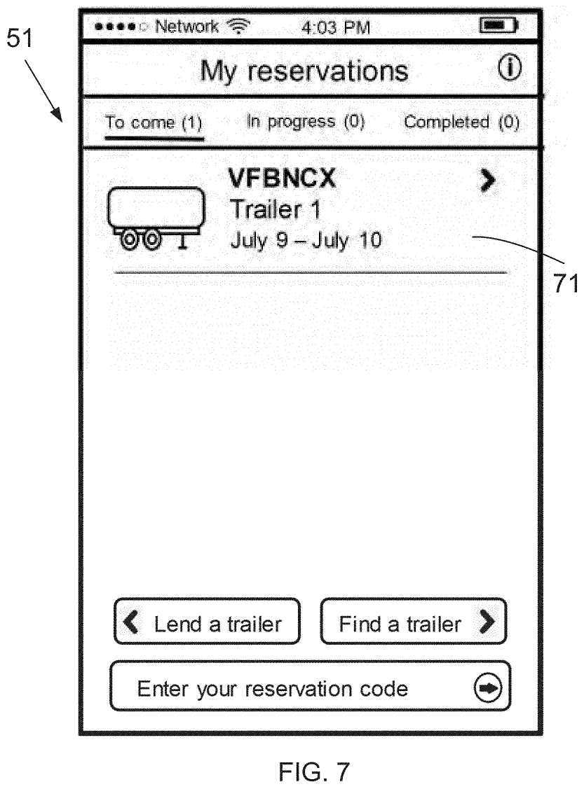

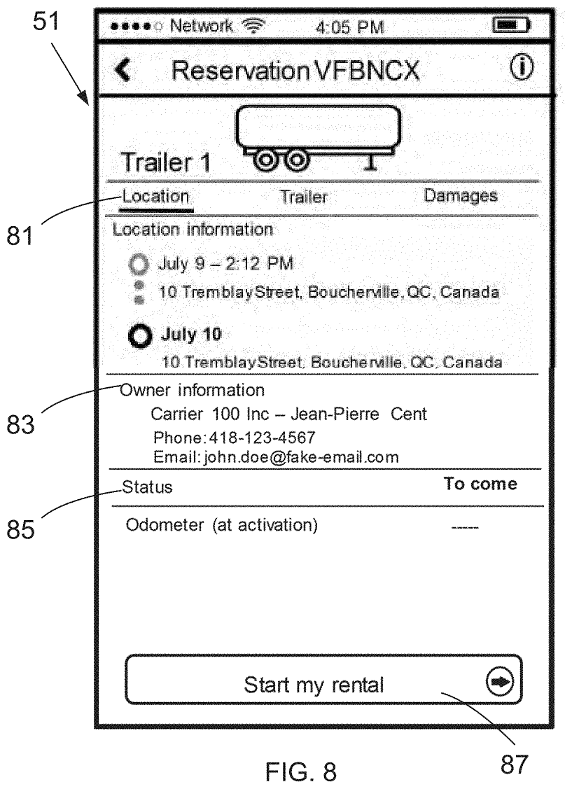

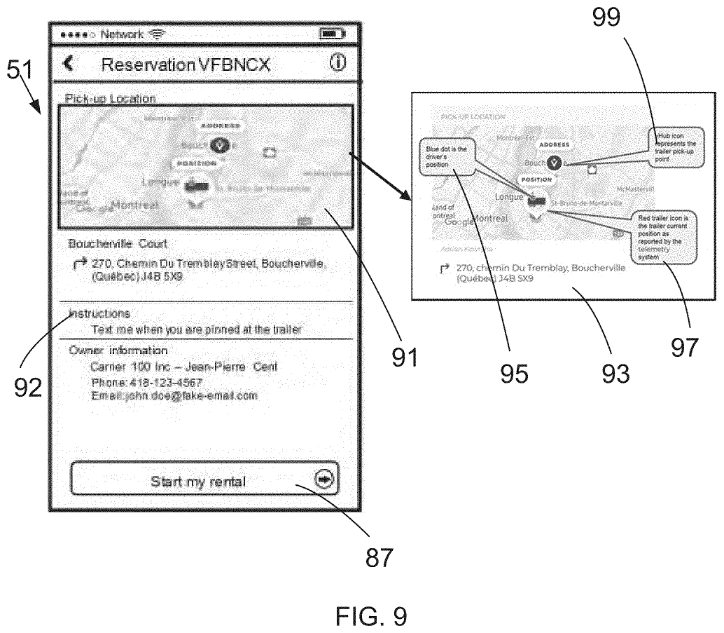

FIG. 6 shows the “Reservation code” tab 61 where the renter enters a reservation code to retrieve a reservation. At FIG. 7, the reservation for a trailer 71 is retrieved. By clicking on the reservation 71, the user can access more information about the reservation, as shown in FIGS. 8 and 9, such as location information 81, owner information 83 and status information 85, pick-up location 91 and instructions 92. Once into the reservation, the application can give a summary of the reservation, the equipment specs and/or existing damages.

The application can show the renter where the unit to activate is (when equipped with telemetry), where the pick-up point is and the driver actual position as shown in FIG. 9. A user of the application can see where the trailer is before driving to the pick-up location. The dot 95 shows the renter's position on the map 91. The icon 99 represents the trailer pick-up location on the map 91. The icon 97 represents the trailer current position as reported by the telemetry system 97. The pick-up address is also provided at 93. The renter is also given yard access instructions 92. The user can click on the button “Start my rental” 67 to start the rental process.

After the user clicks on “Start my rental”, the user is prompted into a guided process where the system instructs the user to perform one or more tasks. The tasks can be pre-programmed or generated based on one or more conditions, such as known damages to the vehicle. For example, the system can instruct the renter to identify the trailer (e.g. take a picture of the plate number of the trailer, manually enter the plate number, validate any other identifying features, etc.); inspect and/or validate known or unknown damages to the trailer; validate the odometer; and/or register/validate engine hours of a temperature control unit of the trailer.

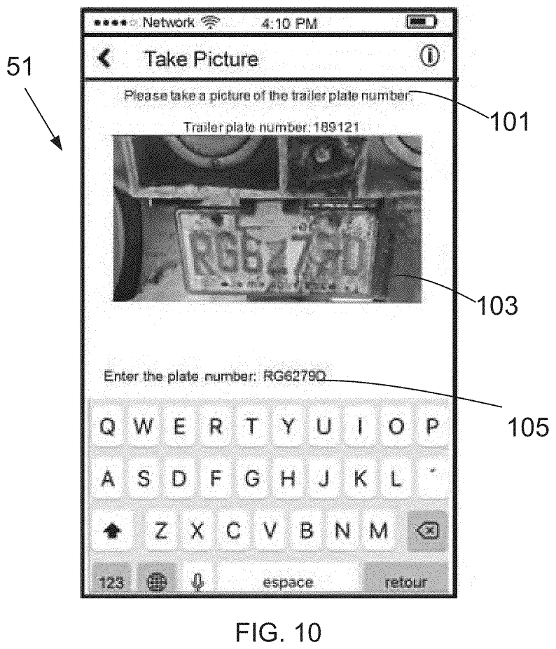

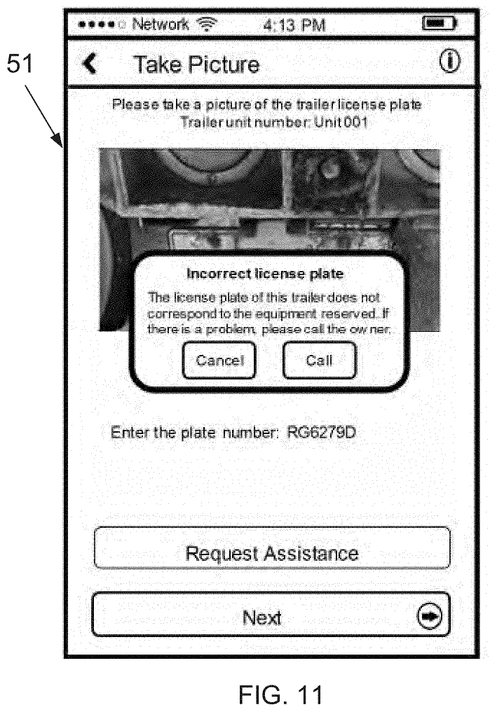

As shown in FIG. 10, the renter is prompted to identify and validate the trailer (e.g. take a picture of the trailer's plate number). The picture 103 is taken by the renter using the camera of the device 51. At 105, the user is prompted to enter the plate number of the trailer. The application verifies that the renter is activating the right trailer. For example, this can be done by comparing the license plate number entered by the user to a pre-registered number store in a database. This can also be accomplished by processing the licensing plate picture to extract the license plate number and comparing it to the pre-registered number. If it is not the right trailer, the application stops the process and informs the renter as shown in FIG. 11.

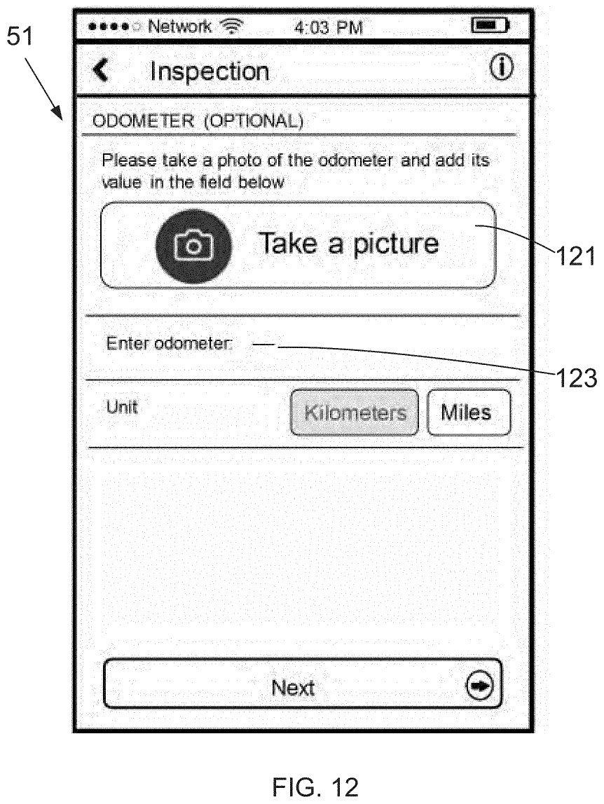

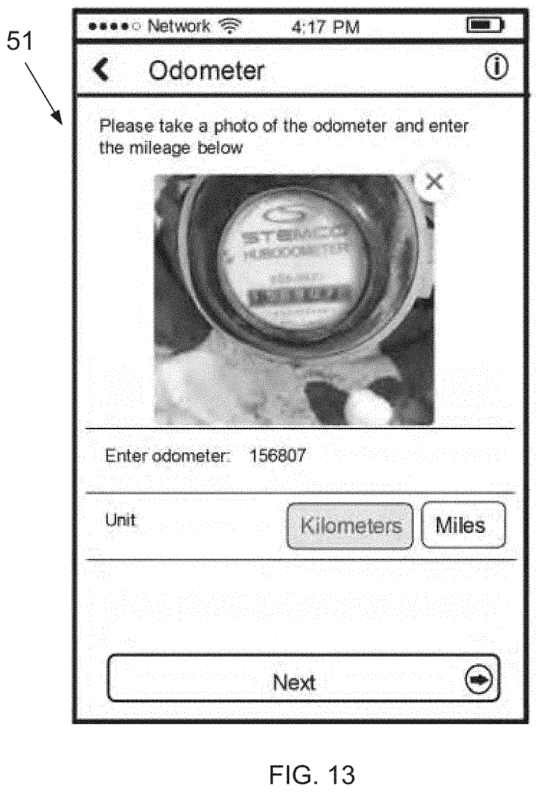

As shown in FIGS. 12 and 13, the renter can be prompted to identify and/or validate the mileage of the trailer. For example, the renter can be prompted to take a photo 121 (or videos and/or other media) of the odometer of the trailer. The system can also instruct the user to enter a value 123 for the odometer. In a further embodiment, the trailer can be equipped with a distance monitoring device, so that the usage mileage can be monitored remotely.

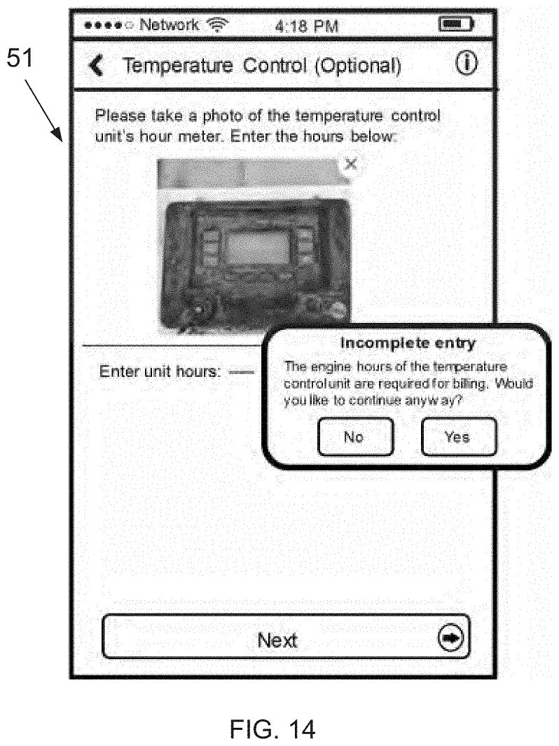

For trailers with temperature control units, engine hours can be entered by the driver as shown in FIG. 14.

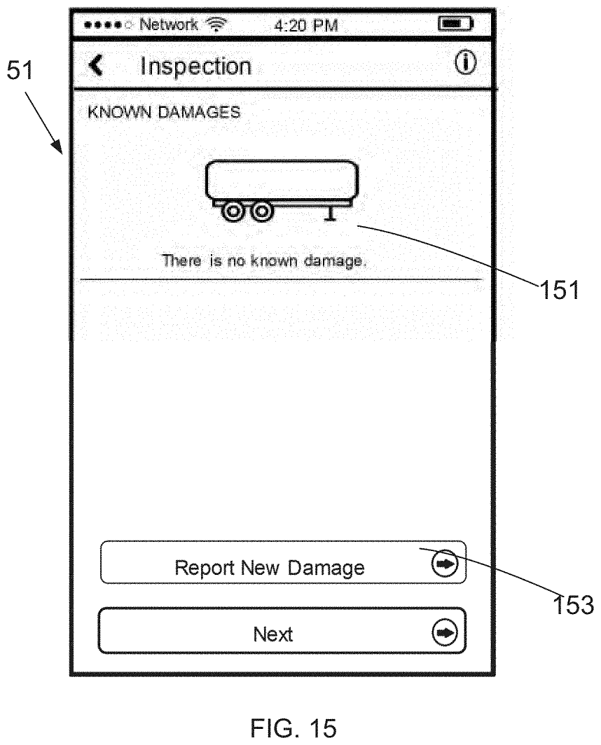

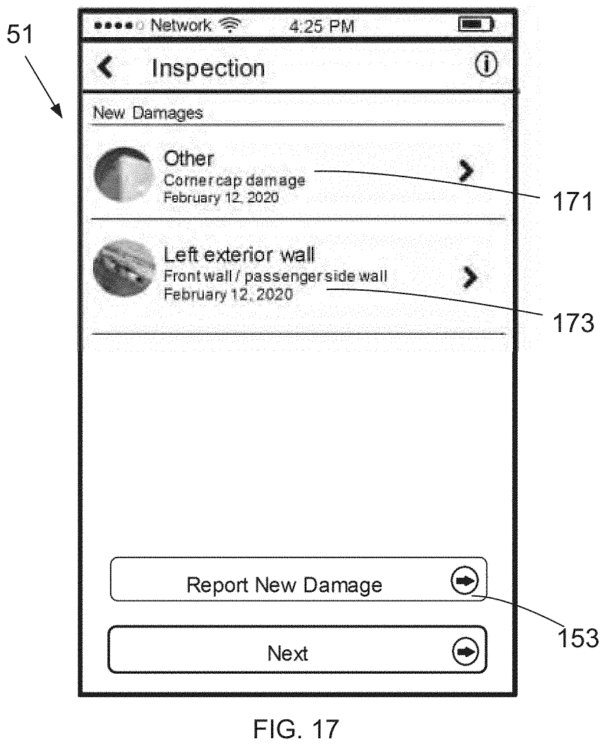

As shown in FIGS. 15-17, the renter is prompted to inspect the vehicle for known or unknown damages. For example, in FIG. 15, the applicant informs the renter that there is no known damages to the trailer at 151. For example, in the event there were known damages to the vehicle, the system can guide the user to the locations of the damages and prompt the user to identify and validate the damages (e.g. take pictures of the damages). The system can prompt the user to inspect the vehicle for new damages that are not registered with the system. For example, the user can click on the button “Report new damages” 153 to report a new damage. The user can report a new damage by taking a picture 161 of the new damage 163 and indicating the location of and other information 165 about the new damage. For example, the system can provide the user with a list of damages, and the user can verify if a discovered damage is part of that list. If it is not, the user can flag the discovered damage as a new damage. If a damage is flagged as a new damage by a user, the system registers it as a new damage it in its database. Before leaving the damage section, the applicant shows all reported damages 171 and 173 to the driver to make sure nothing is unreported as shown in FIG. 17.

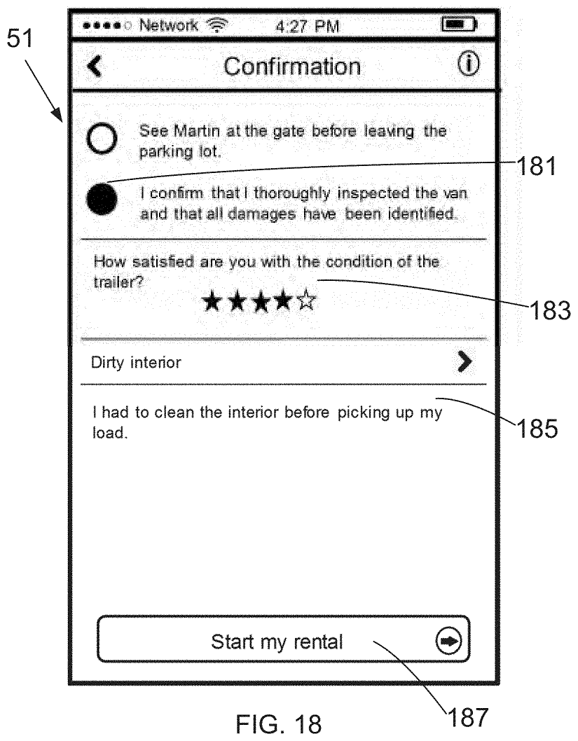

As shown in FIG. 18, the application displays a confirmation tab, prompting the user to confirm one or more aspects of the vehicle. The confirmation tab can also prompt the user to confirm that all damages has been identified at 181 and prompt the user about the condition of the trailer at 185. The confirmation tab can also ask the user to enter a satisfaction level at 183. Further, the renter can be prompted to confirm any special instructions from the owner of the trailer and/or provide feedback about the trailer.

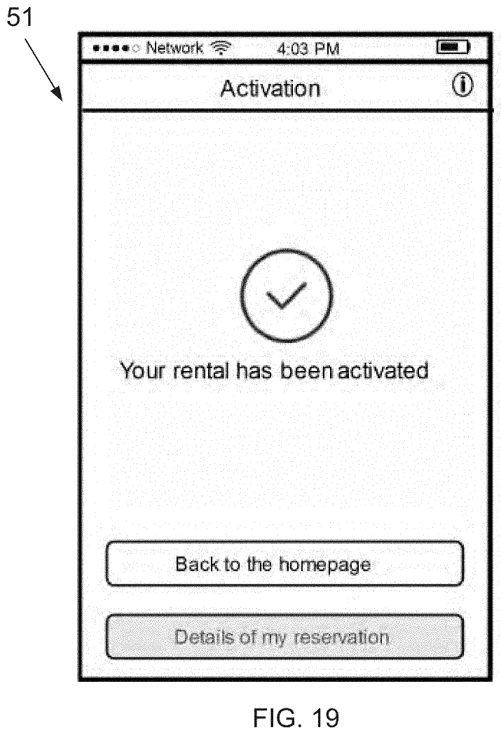

After that, the user can click on the button “Start my rental” at 187 to start the rental. After clicking on the button 187, the rental is activated as shown on FIG. 19. When the confirmation message is displayed, the renter can start using the trailer. The rental contract is also activated and the billing process is triggered.

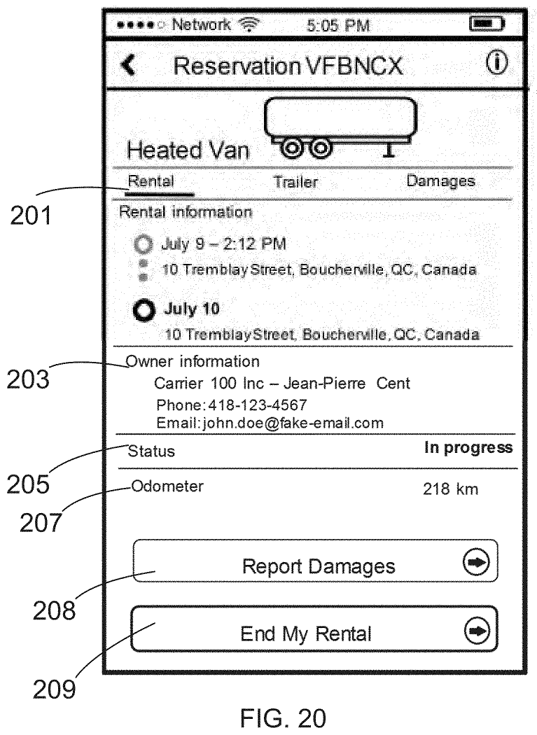

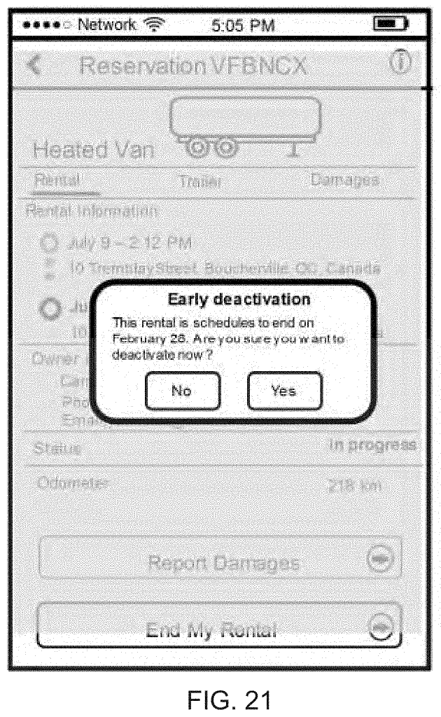

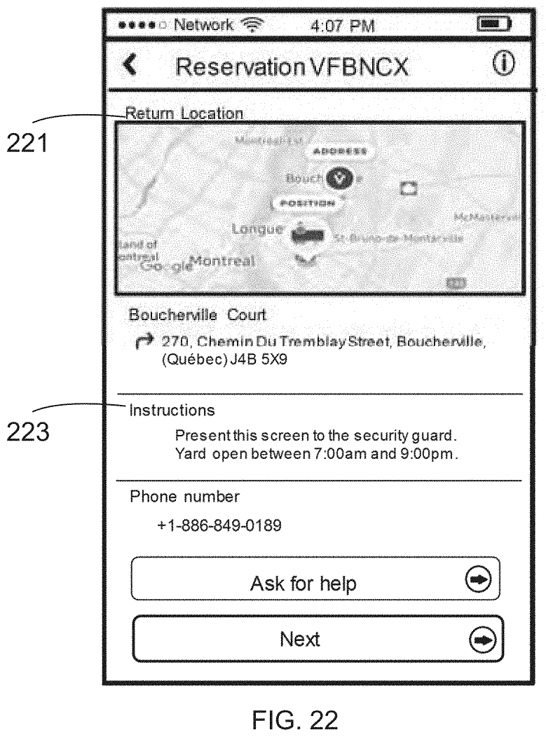

FIGS. 20 to 31 show embodiments of the system regarding the de-activation of the rental of the trailer. Referring to FIGS. 20-22, the de-activation process starts with a recap of the reservation, such as rental information 201, owner information 203, status information 205, odometer information 207, return location 221 and instructions 223, etc. As shown in FIG. 21, if the renter is returning the trailer before the expected deactivation date, a message is prompted to renter. Just like at the activation process, the application shows the renter where to return the trailer

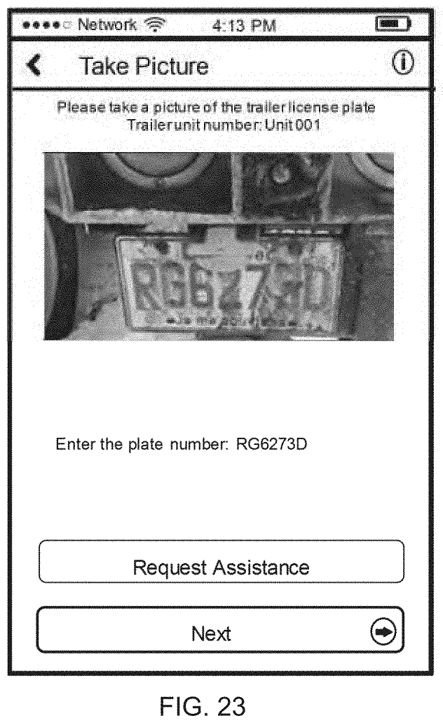

As shown in FIG. 23, just like the activation process, the application verifies that the renter is deactivating the right trailer. The user is prompted to identify and/or validate the trailer using a photo (or videos, other media, etc.) of the license plate number. For example, the application asks for the plate number and a picture of the plate number. If it is not the right trailer, the process stops and the users can be prompted to correct the issue.

As shown in FIGS. 23-27, the application prompts the renter to identify and/or validate parts of the trailer for damages in order to complete the deactivation process. The renter can be prompted into a guided process where the system instructs the user to perform one or more tasks. For example, the tasks can be pre-programmed or based on more or more conditions, such as the presence or absence of damages. For example, the tasks can be generated based on known damages to the vehicle. For example, the system can prompt the renter to: inspect for damages at one or more locations on the trailer; take pictures of one or more location, etc.

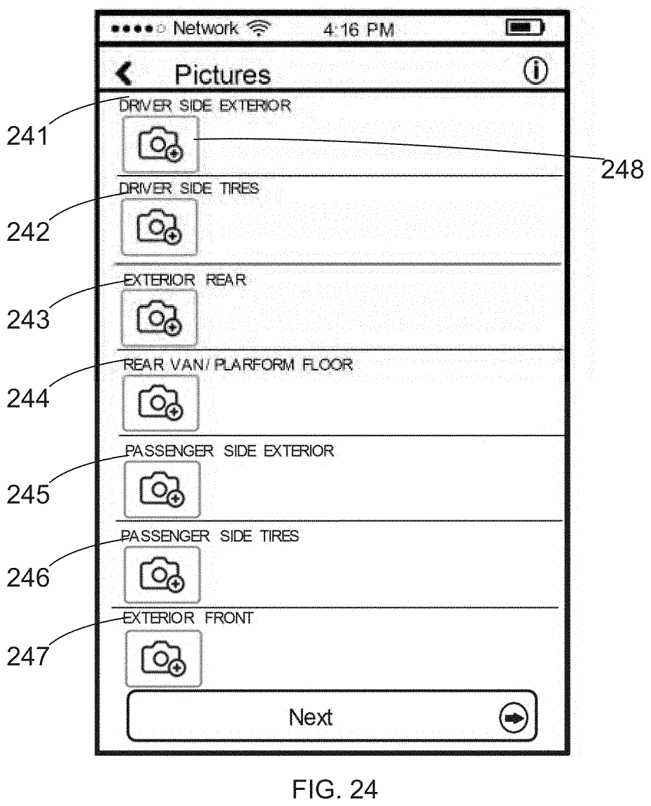

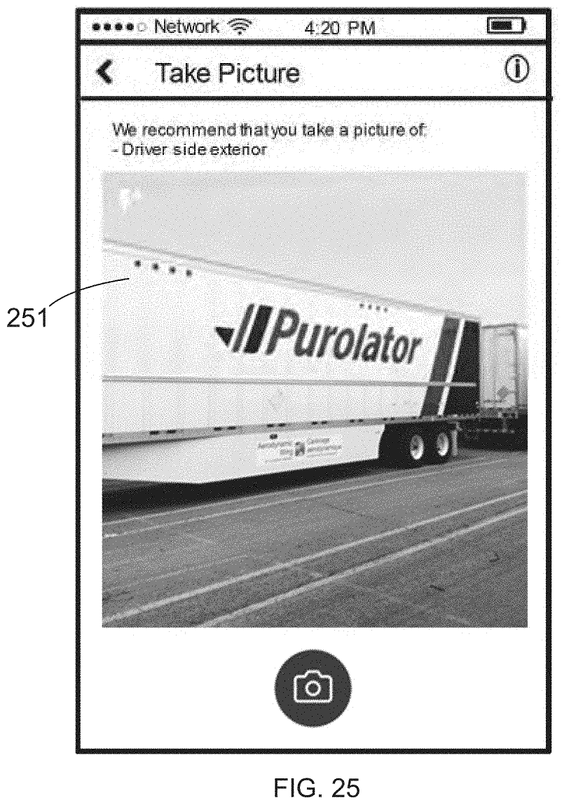

As shown in FIG. 24, the system prompts the renter to take photos, videos and/or other media of different locations of the vehicle, such as: the driver side exterior 241, the driver side tires 242, the exterior rear 243, the rear van/platform floor 244, the passenger side exterior 245, the passenger side tires 246 and the exterior front 247. As shown in FIG. 25, a photo 251 (or videos, other media, etc.) of the driver side exterior is taken by the renter.

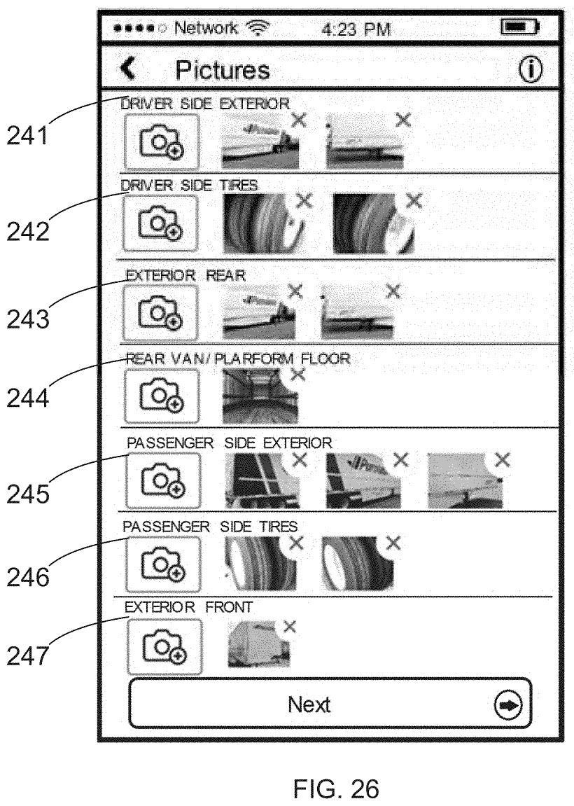

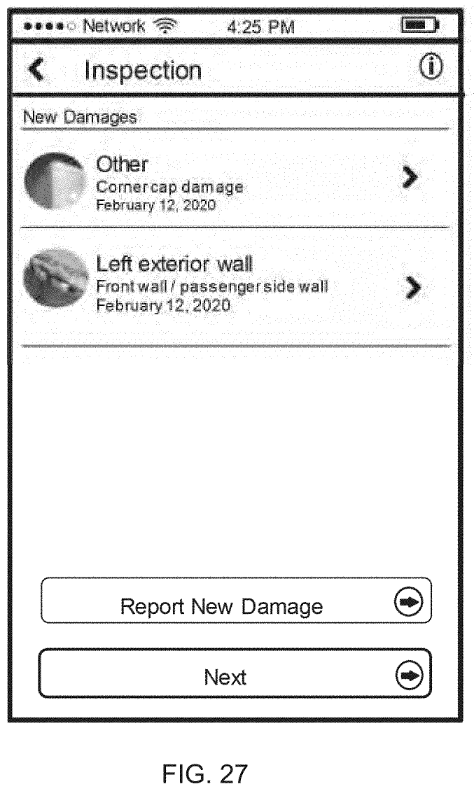

FIG. 26 shows photos that have been taken by the renter for the driver side exterior 241, the driver side tires 242, the exterior rear 243, the rear van/platform floor 244, the passenger side exterior 245, the passenger side tires 246 and the exterior front 247. As shown in FIG. 27, the user is prompted to can report new damages.

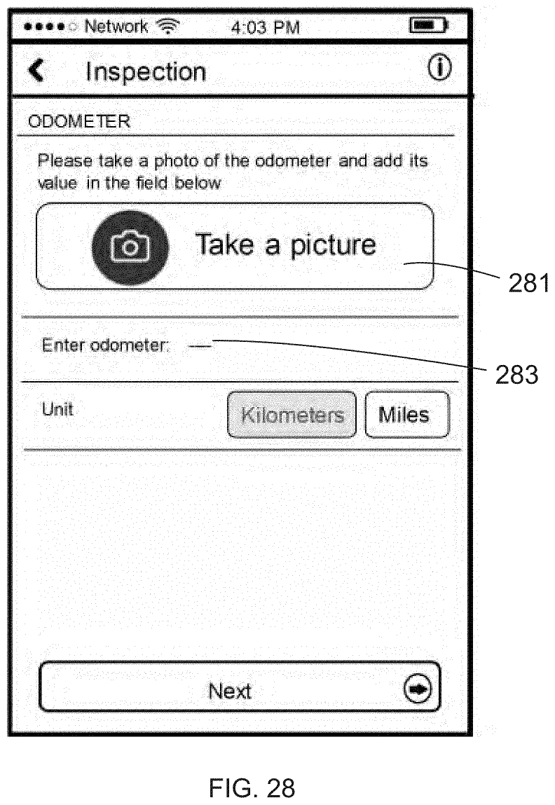

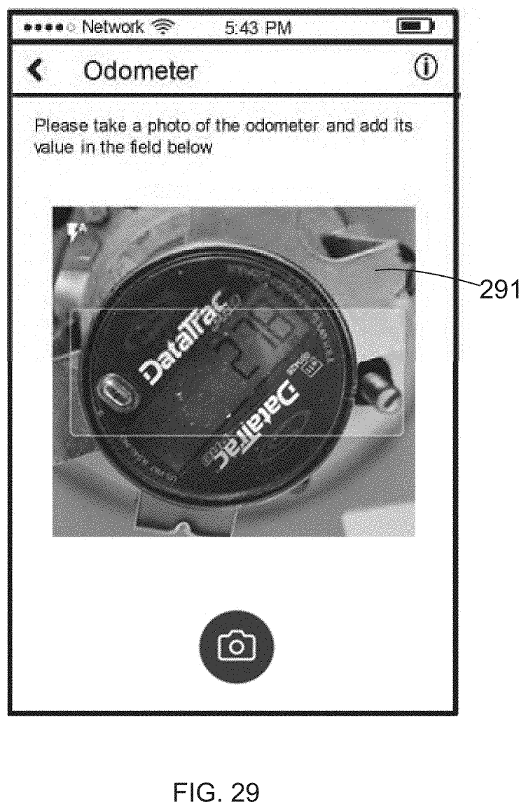

As shown in FIGS. 28-29, the renter is prompted to validate the mileage on the odometer of the vehicle at 281 and 283. The system instructs the user to enter a value for the odometer 283. FIG. 29 shows a picture 291 of the odometer that has been taken by the user.

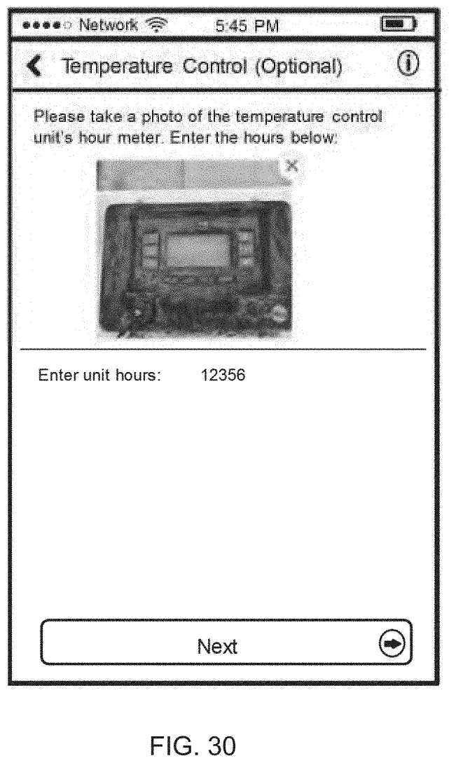

For trailers with temperature control units, engine hours can also be entered by the renter as shown in FIG. 30.

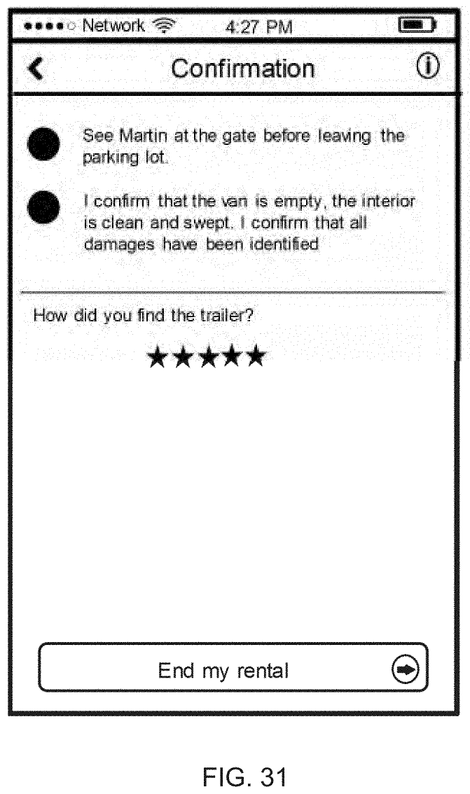

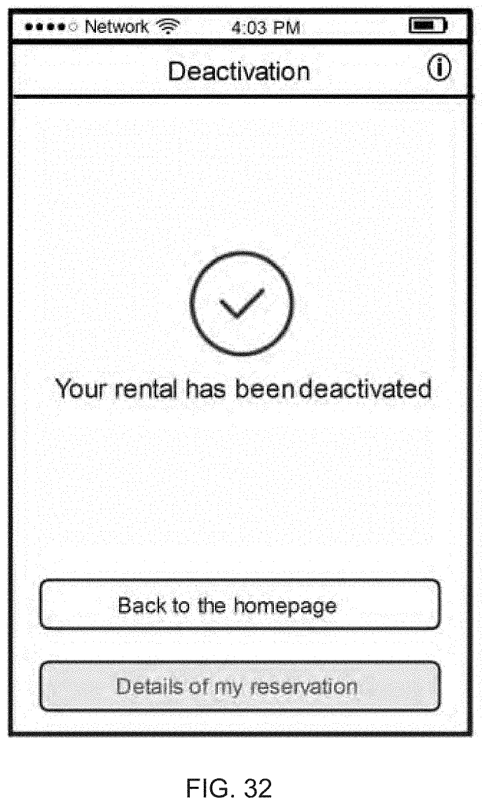

As shown in FIG. 31, the application displays a confirmation tab at 231, asking the user to confirm one or more aspects of the trailer and/or the reservation. For example, the confirmation tab can ask the user to confirm that the vehicle is empty and that the interior is clean and swept. The confirmation tab can also ask the user to confirm that all damages has been identified. After that, the user can click on the button “End my rental” to end the rental. After that, the rental is de-activated as shown on FIG. 32.

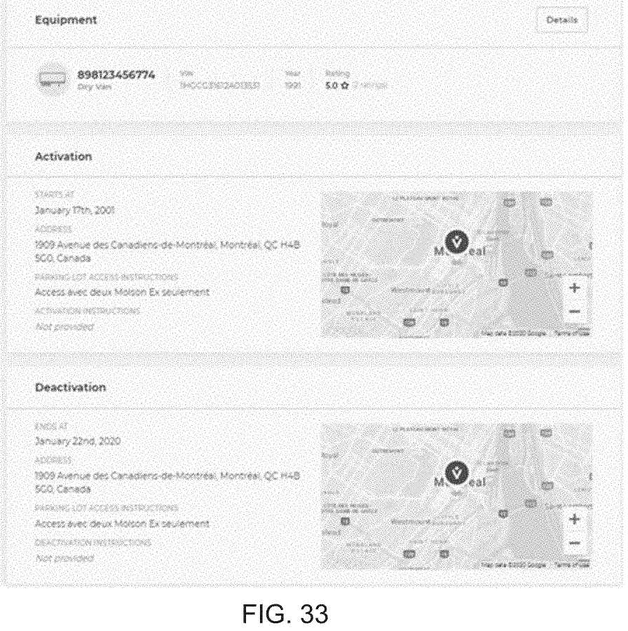

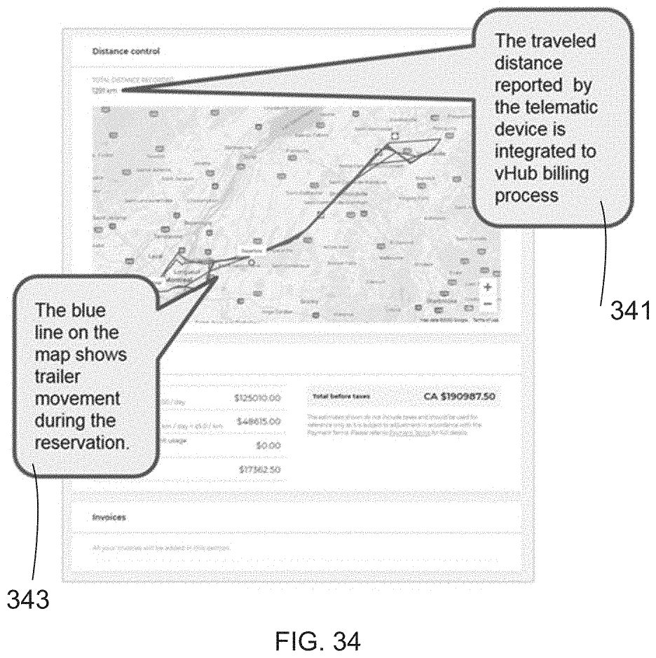

As shown in FIGS. 33-34, the trailer movement during the rental can be archived for later use within the reservations screen of the mobile application and or web application. For example, the traveled distance 341 reported by the tracking device of the trailer can be integrated into the application for billing purposes. The trailer movement can be plotted on a line 343 on a map to shown the trailer route during the reservation.

The systems and methods described in the present subject matter provide tools for inspecting movable equipment such as vehicles, trailers, etc. For example, the movable equipment parts that may need to be checked can include: tires, lights, brakes and/or wheel bearings, hitch and/or coupler, safety chains, plugs, springs, axle, winches and/or tie-downs, jack, etc. For example, when tires are not inflated to the correct pressure (either with too much or too little pressure), they might wear more quickly. Further, the wear caused by improper tire pressure can make them more susceptible to failure during use. For example, before renting a movable equipment, the renter may want to determine the wear on a tire by checking the tread depth and its evenness across the tire. For example, the systems described in the present subject matter may guide the renter to take photos, videos and/or other media of the tire and determine whether the tire is safe for use. Such photos, videos and/or other media may be saved in a database of the system for future in assessing the safety of the tire.

If the movable equipment brakes are not working properly, it increases the likelihood of collision. When the movable equipment brakes are not working properly, they put unnecessary extra stress on the tow vehicle's brakes, causing them to have to be replaced sooner and increasing the potential for them to fail. Therefore, whenever necessary, the described system may guide a renter in performing a brake test before taking the movable equipment on the road. For example, if the movable equipment uses electric brakes rather, the described system may guide a renter to test the system battery on the movable equipment to make sure it is charged and/or check the condition of the breakaway switch.

In guiding the renter to check the movable equipment hitch and coupler, the described system and method may guide the user to verify whether the frame mounting bolts is tight, and there are cracks anywhere on the receiver, shank, or tow ball. The renter may also be guided to check whether the coupler jaws fit tight over the tow ball and/or the safety latch needs to be pinned. The described system and method may guide the renter to take photos, videos and/or other media of the hitch and coupler, store such photos, videos and/or other media in a database and determine whether they are safe for use.

The described system and method may guide the renter to inspect the safety chains, take photos, videos and/or other media of them and determine whether the links are not worn or damaged. The described system and method may guide the renter to inspect the movable equipment lights (e.g. turn signal and brake lights, etc.) and take photos, videos and/or other media of them for verification purposes.

The described system and method may guide the renter in inspecting the movable equipment plugs, such as the wiring connections between the tow vehicle and the movable equipment. Such connections can wear, and by capturing photos, videos and/or electronic media of them during each inspection, the described system can create a database of such photos, videos and/or electronic media to monitor the wear and tear. The renter can be guided to check the receptacle and the plug for broken and/or loose wiring. The renter can also be guided by the system to inspect and capture photos, videos and/or other media of the wiring under the movable equipment. Other parts of the movable equipment can be inspected accordingly.

The described system and method may guide the renter to take photos, videos and/or other media of parts of the movable equipment (such as the parts described above, etc.) and capture photos, videos and/or other media of such parts. The described system and method may further store such photos, videos and/or other media in a database and use them later on in assessing the safety of the movable equipment.

The person skilled in the art would understand that the various properties or features presented in a given example can be added and/or used, when applicable, to any other example covered by the general scope of the present disclosure.

The examples of preceding paragraphs of the present disclosure are presented in such a manner in the present disclosure so as to demonstrate that every combination of examples, when applicable can be made. These examples have thus been presented in the description in a manner equivalent to making dependent claims for all the examples that depend upon any of the preceding claims (covering the previously presented examples), thereby demonstrating that they can be combined together in all possible manners.

The present disclosure has been described with regard to specific examples. The description was intended to help the understanding of the disclosure, rather than to limit its scope. It will be apparent to one skilled in the art that various modifications can be made to the disclosure without departing from the scope of the disclosure as described herein, and such modifications are intended to be covered by the present document.

1. A system for reserving a movable equipment, comprising:
a user tracking device configured to track a location of a user; and
a reservation management device configured to:
receive the location of the movable equipment;
receive the location of the user from the user tracking device;
provide the location of the movable equipment, a pick-up point for picking the movable equipment and/or access instructions at the pick-up point; and
determine whether the user has activated reservation of the movable equipment at the pick-up location.

2. The system of claim 1, wherein the reservation management device is configured to provide a summary of the reservation, specifications of the movable equipment and existing damages to the movable equipment.

3. The system of claim 1, wherein the reservation management device is configured to:
determine whether the movable equipment is equipped with a temperature control unit; and
register engine hours of the temperature control unit.

4. The system of claim 1, wherein the reservation management device is configured to determine damages to the movable equipment.

5. The system of claim 1, wherein the reservation management device is configured to:
provide reported damages to the movable equipment to the user;
prompt the user identify and/or validate damages to the movable equipment; and
register the damages reported by the user.

6. The system of claim 1, wherein the reservation management device is configured to:
provide instructions with respect to inspection, setup and operation of the movable equipment to the user; and
register user feedback.

7. The system of claim 1, wherein the reservation management device is configured to:
provide to the user a return location for returning the movable equipment;
register a mileage for the movable equipment; and
determine whether the user has de-activated reservation of the movable equipment at the return location.

8. The system of the preceding claim, wherein the reservation management device is configured to prompt the user to identify the movable equipment.

9. The system of the preceding claim, wherein the reservation management device is configured to guide the user in inspecting parts of the movable equipment.

10. The system of claim 1 further comprising an equipment tracking device configured to track a location of the movable equipment.

11. The system of claim 1, wherein the equipment tracking device and the user tracking device comprise GPS receivers.

12. A method for reserving a movable equipment executed by a reservation management device, comprising:
receiving a location of the movable equipment;
receiving a location of the user;
providing the location of the movable equipment, a pick-up point for picking the movable equipment and/or access instructions at the pick-up point; and
determining whether the user has activated reservation of the movable equipment at the pick-up location.

13. The method of claim 11, comprising providing a summary of the reservation, specifications of the movable equipment and existing damages to the movable equipment.

14. The method of claim 11, comprising:
determining whether the movable equipment is equipped with a temperature control unit; and
registering engine hours of the temperature control unit.

15. The method of claim 11, comprising:
determining damages to the movable equipment;
providing reported damages to the movable equipment to the user;
prompting the user to identify and/or validate damages to the movable equipment; and
registering the damages reported by the user.

16. The method of claim 11, comprising:
providing instructions with respect to inspection, setup and operation of the movable equipment to the user;
registering user feedback;
providing to the user a return location for returning the movable equipment;
registering a mileage for the movable equipment; and
determining whether the user has de-activated reservation of the movable equipment at the return location.

17. The method of claim 11, comprising:
prompting the user to identify the movable equipment; and
guiding the user in inspecting parts of the movable equipment.
